(19) United States
(12) Patent Application Publication
(10) Pub. No.: US 2008/0264441 A1
(43) Pub. Date: Oct. 30, 2008

(54) METHOD FOR REMOVING RESIDUALS FROM PHOTOMASK

(76) Inventor: YOJI TAKAGI, Narita-Shi (JP)

Correspondence Address: APPLIED MATERIALS/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/742,385

(22) Filed: Apr. 30, 2007

(51) Int. Cl. B08B 3/12

(52) U.S. Cl. 134/1

(57) ABSTRACT

Methods for removing adhesive from a photomask after a pellicle has been removed from the photomask are herein disclosed. In some embodiments, after a pellicle is removed from a photomask, adhesive residue remaining on the photomask is subjected to removal by an energy source, such as an excimer laser. The excimer laser may be in close proximity to a surface of the photomask which contains the adhesive residue. In some embodiments, removal of the photomask may be followed by a physical cleaning process such as megasonic cleaning or jet nozzle cleaning to remove any residual adhesive left behind.

### FIELD OF INVENTION

Photomask processing.

### BACKGROUND OF INVENTION

The final fabrication step of a photomask (also referred to as a mask) before use is the adhering of a protective covering such as a pellicle which can be stretched over a frame that is then attached to the photomask to shield the patterned area from any particles. In general, a pellicle is a transparent membrane that seals the mask (also referred to as a reticle) from harmful particle contamination. The pellicle is designed to be placed directly over the mask to prevent particulates and other contaminants from falling onto the surface of the mask. Thus, contaminants will be deposited on the surface of the pellicle membrane instead of on the surface of the mask. These contaminants can then be removed without requiring cleaning of the mask surface. The pellicle membrane is typically held at a fixed distance from the mask surface by a frame. This serves to keep any particle contaminants out of focus and prevents them from being imaged onto a wafer during photolithography.

Typically, photomasks are expensive and complex, and some photomasks contain defects. As a result, there exists a strong economic incentive to repair these defects. Common mask defects are classified by their influence on the aerial image (the optical pattern that is generated by illumination through the mask): (a) opaque defects, which are extraneous (spurious) features typically to be repaired by a subtractive method (e.g., opaque spots or blobs in areas to be left transparent, unwanted necks or bridges between features, unwanted spikes or protuberances on the side of features) or, (b) clear defects, which are missing or incomplete features, typically to be repaired by an additive method (e.g., pin-holes, broken or thinned lines, notches, and corner defects).

Mask defects can further be classified as hard or soft defects. A soft defect is typically any defect that can be removed by a cleaning process, whereas a hard defect cannot be removed by a cleaning process. For example, particles, contamination, residue or stains on the chrome/quartz are classified as soft defects. Also, missing or extra features in the chrome/absorber/phase shifter pinholes or quartz pits are classified as hard defects. Types of hard defects include, for example, pinholes, pinspots, intrusions, corner defects, missing features, absorber transmission defects, protrusions, and semi-transparent defect in a clear area.

Other types of defects include those that result from errors in the original mask data tape and also mask misprocessing (misplacement and missizing of geometries) and those that result from CD (critical dimension) variations across the masks and edge quality of features, e.g., line edge roughness.

In some applications, a photomask can be repaired by the following method: (a) the mask is inspected, e.g., using optical microscopy; if found to be defective, (b) the pellicle protecting the mask is removed; (c) the mask is cleaned of pellicle residue and other organic and/or inorganic contaminants; (d) the mask is placed in a repair apparatus, and aligned so that the previously identified defects can be precisely located; (e) a lithography probe is directed to the first defect and a first deposit is made; (f) if necessary, the mask is submitted to an external process, such as heating, UV irradiation, exposure to a chemical vapor, and the like that will induce layer curing; the process is repeated for each layer and each defect as required; (g) the mask is optionally cleaned, inspected (as in (a)) for unrepaired defects and reintroduced in fabrication if determined to be of sufficiently good quality such as, for example, production-quality.

When the pellicle is removed, as in step (b) above, an adhesive residue where the frame contacts the mask will remain on the mask. Typically, a sulfuric acid-hydrogen peroxide mixture (SPM) can be used to remove pellicle residue. As a result, however, sulfur can remain on the mask surface, thus adversely affecting subsequent operations in the photomask production process.

### SUMMARY OF INVENTION

According to some embodiments, a method comprising directing energy from an energy source at a substance on a photomask from which a pellicle has been removed and subjecting any remaining substance on the photomask to a physical cleaning process can be performed to remove the substance from the photomask.

According to some embodiments, a method comprising removing a pellicle from a photomask, removing an adhesive remaining on the photomask after pellicle removal, and cleaning a remaining residue of the adhesive on the photomask using a physical cleaning method can be performed to remove the adhesive from the photomask.

### BRIEF DESCRIPTION OF DRAWINGS

FIG. 1A illustrates a plan view of a photomask template with a chrome-containing layer and a photoresist layer.

FIG. 1B illustrates a plan view of the photomask template of FIG. 1A being subjected to e-beam or laser photolithography.

FIG. 1C illustrates a plan view of the photomask template of FIG. 1B following removal of portions of the photoresist layer.

FIG. 1D illustrates a plan view of the photomask template of FIG. 1C following removal of portion of the chrome-containing layer.

FIG. 1E illustrates a plan view of the photomask template of FIG. 1D following removal of the photoresist layer.

FIG. 1F illustrates a cross-sectional view of a resultant photomask of FIG. 1E after a pellicle assembly has been positioned thereon.

FIG. 2 is a flowchart of an embodiment of a method for removing a substance from a surface of a photomask after pellicle removal.

FIG. 3 is a schematic side view of a photomask in a process chamber during removal of a substance from a surface of the photomask after pellicle removal.

FIG. 4 is a schematic side view of a photomask in a cleaning process chamber during removal of residual substance from a surface of a photomask using megasonic cleaning after removal.

FIG. 5 is a schematic side view of a photomask in a cleaning process chamber during removal of residual substance from a surface of a photomask using jet nozzle cleaning after removal.

### DETAILED DESCRIPTION

Embodiments of the present invention are directed to methods for removing adhesive from a photomask after a pellicle has been removed from the photomask. In some embodiments, after the pellicle is removed from the photomask, the photomask is subjected to energy from an energy source. The energy source may be in close proximity to a surface of the photomask which contains the adhesive. In some embodiments, energy from an energy source directed to the photomask and may be followed by a physical cleaning process such as megasonic cleaning or jet nozzle cleaning to remove any residual adhesive left behind on the photomask.

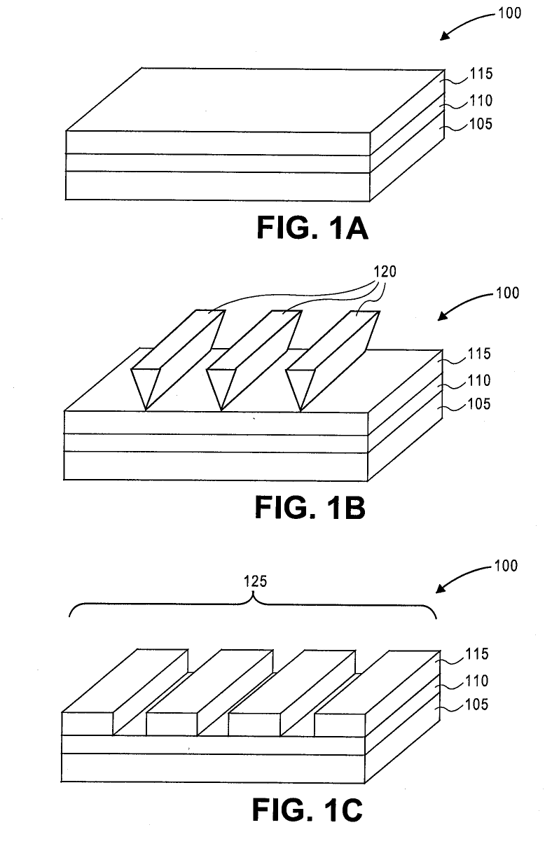

FIGS. 1A-1F illustrate a typical process flow for forming a photomask. FIGS. 1A-1F illustrate plan views of a photomask template during various operations of the process flow. In FIG. 1A, a substrate 105 is coated with a chrome-containing layer 110 followed by a coating of a photoresist (PR) layer 115 to form photomask template 100. A photomask template can include a quartz, a glass or a sapphire substrate, a metal-containing layer (such as a chrome-containing, molybdenum-containing, or tungsten-containing material, for example), an anti-reflective coating layer and a photoresist layer. In one embodiment, the photoresist layer is combined with an anti-reflective coating material. The metal-containing layer can be from about 300 nm to about one micrometer (μm), while the photoresist layer can be from about 3000 Angstroms (Å) to about 50,000 Å. Photomask sizes range from about 3 in² (7.62 cm²) to 11 in² (27.94 cm²), preferably 5 in² (12.7 cm²) to 6 in² (15.24 cm²). In one embodiment, substrate 105 is a quartz substrate between about 5 in² (12.7 cm²) to 6 in² (15.24 cm²). Chrome-containing layer 110 may be formed by a process such as sputtering. Photoresist layer 115 may be formed by a spinning process followed by polymerization and hardening.

In FIG. 1B, photomask template 100 is subjected to e-beam or laser lithography equipment to write (arrows 120) a predetermined pattern 125 (not shown in this figure) on the surface of photoresist layer 115. In FIG. 1C, developer chemicals can be applied to photomask template 100 to finalize predetermined pattern 125 over the photoresist area which was exposed by the e-beam or laser. The developer chemicals only remove photoresist in the areas subjected to the e-beam or laser. In FIG. 1D, dry or wet etching can be used to etch chrome-containing layer 110 in the areas in which the photoresist has been removed from photomask template 100. The area covered by the remaining photoresist remains unaffected.

In FIG. 1E, remaining photoresist is removed via a strip process (wet or dry), followed by cleaning and drying operations. At this stage, the surface of photomask template 100 is composed of dark areas covered by chrome-containing material or clear areas in which the chrome-containing material has been removed (naked quartz). The quartz is able to transmit incoming light from a light source. The patterned photomask template is typically referred to as a photomask (photomask 130).

FIG. 1F illustrates a cross-sectional view of a photomask with photomask 130 after a pellicle assembly 135 has been positioned, or mounted, thereon. Photomask 130 is bonded to pellicle frame 135. Pellicle 140 of pellicle assembly 135 may be positioned at a distance from photomask 130, typically from about 4 millimeters to about 6 millimeters. Before mounting, pellicle assembly 135 includes pellicle 140 and backside cover 145 (shown in dotted lines) supported by pellicle frame 135. Backside cover 145 is removed before mounting.

Pellicle 140 may be a thin film membrane formed of a material such as nitrocellulose, cellulose acetate, an amorphous fluoropolymer, such as TEFLON® AF available from E. I. du Pont de Nemours and Company, Delaware, U.S.A. or CYTOP® available from Asahi Glass Company, Japan, or any another suitable film that is transparent to wavelengths in the UV, deep ultraviolet (DUV), extreme ultraviolet (EUV) and/or vacuum ultraviolet (VUV) ranges. Pellicle 140 may be prepared by conventional techniques such as dip-coating, chemical vapor deposition or spin casting. In some embodiments, pellicle 140 includes an anti-reflective coating 150 on a top surface, a bottom surface or a combination thereof. Anti-reflective coating 150 can be a low refractive index material, such as, for example, a fluoropolymer, to create a low energy surface, thus making it easier to remove particles from the surface of pellicle 140. Pellicle frame 135 may be formed from anodized aluminum, stainless steel, plastic or any other suitable material that does not degrade or outgas when exposed to electromagnetic energy within a lithography system. In some embodiments, pellicle frame 135 may include vent with filter 165 to equalize the air pressure differentials inside and outside of pellicle assembly 135.

In some embodiments, pellicle frame 135 is adhered to the periphery of pellicle 140 by an adhesive 170. Examples of adhesives include, but are not limited to, polybutene resin, polyvinyl acetate resin, acrylic resin, silicon resin, epoxy resin and fluoroplastics. Similarly, pellicle frame 135 may also be bonded to backside cover 145 by a carrier or non-carrier adhesive 155 pre-applied on the frame with release liner 160. In one embodiment, adhesive 155 is a carrier adhesive, such as a double-sided coated pressure-sensitive acrylic or rubber adhesive with a polyurethane foam, vinyl foam or solid carrier. In another embodiment, adhesive 155 is a non-carrier adhesive in the form of a one-layer transfer tape or cast. Non-carrier adhesive 155 can include hot melt, UV-cured or emulsion pressure sensitive adhesives. Following the assembly of photomask 130 in pellicle frame 135 and positioning of pellicle 130, the assembly may be used, for example, to transfer patterns to a wafer in the formation of integrated circuit structures (e.g., microprocessor circuits in chips).

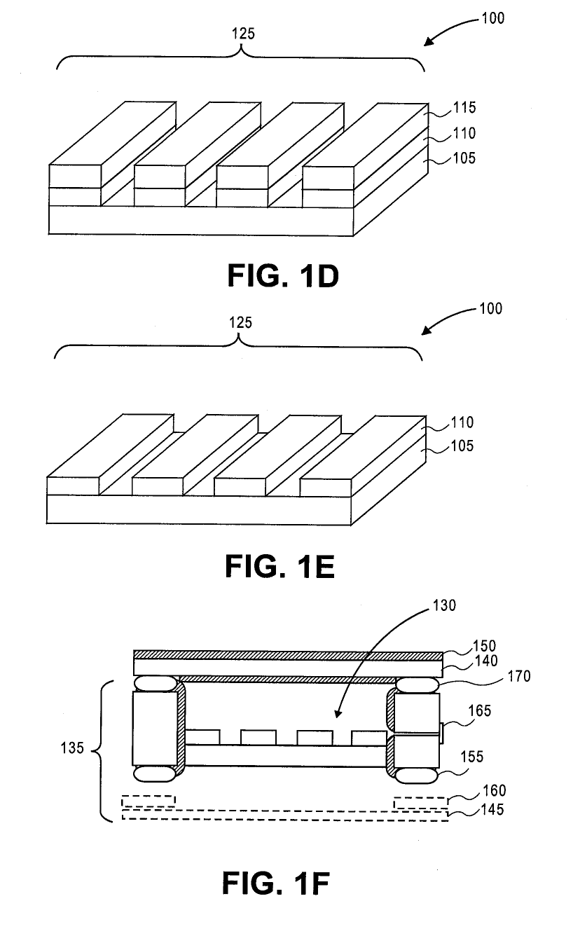

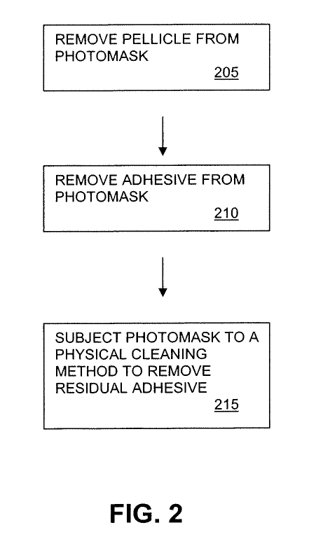

FIG. 2 is a schematic of an embodiment of a method for removing adhesive from a photomask substrate following removal of a pellicle therefrom without using chemical agents in accordance with embodiments of the invention. In some embodiments, a pellicle can be removed from a photomask during a process of fabricating a photomask. A pellicle can be removed towards the end of a photomask fabrication process after, for example, inspection for defects and subsequent repair of the photomask. In addition, a pellicle can be removed and replaced after it has been soiled or damaged at a facility performing photolithography using a photomask with a pellicle attached thereon. Pellicle removal is generally performed by manual processes. As a result of pellicle removal, the pellicle frame formerly attached to the photomask by an adhesive will leave an adhesive residue on the periphery of the photomask. In some embodiments, the adhesive residue is in the shape of a rectangle around the periphery of the photomask. Thus, according to one embodiment, once the pellicle is removed (205), the photomask can be removed with an excimer laser to remove the adhesive residue (210). In some embodiments, the excimer laser can exude UV light in a wavelength range from about 165 nanometer (nm) to about 185 nm. In one embodiment, the wavelength is 172 nm. Additionally, the excimer laser can be positioned at a distance in a range from about 0.5 mm to about 2.0 mm from the surface of the photomask. In one embodiment, the excimer laser can be positioned at a distance at about 1.0 mm from the photomask. The excimer laser can be programmed at an intensity from about 35 megawatts per centimeter squared (mW/cm²) to about 45 mW/cm². In one embodiment, the excimer laser is programmed at 40 mW/cm². Removal using the excimer laser can be performed in a chamber in an oxygen or air atmosphere at standard pressure (see FIG. 3). In some embodiments, the application time is from about 8 minutes to about 12 minutes, preferably about 10 minutes.

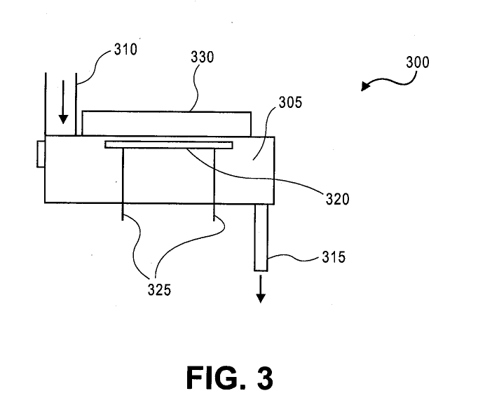

Continuing to refer to FIG. 2, any remaining adhesive residue can be removed from the photomask using a physical cleaning method such as megasonic cleaning or jet nozzle cleaning (215). “Megasonic cleaning” refers to a cleaning process in which high-frequency mechanical vibrations combined with the application of directed beams that run parallel to a substrate surface work to remove particles from a substrate surface. The application of directed beams removes particles by a shearing force. In some applications, megasonic cleaning can be performed in a chamber such as Oasis Clean®, available from Applied Materials, Inc., California, U.S.A (see FIG. 4). Megasonic cleaning can be performed at frequency between about 950 kiloHertz and about 2 megaHertz in combination with a cleaning solution. The cleaning solution can be, for example, an ammonia/hydrogen peroxide mixture (APM) or ozone in deionized water (O3/DI) at about 37 degrees Celsius (⁰C), and about 50⁰ C. In some applications, megasonic cleaning can be performed on the photomask from between about 2 minutes to about 10 minutes.

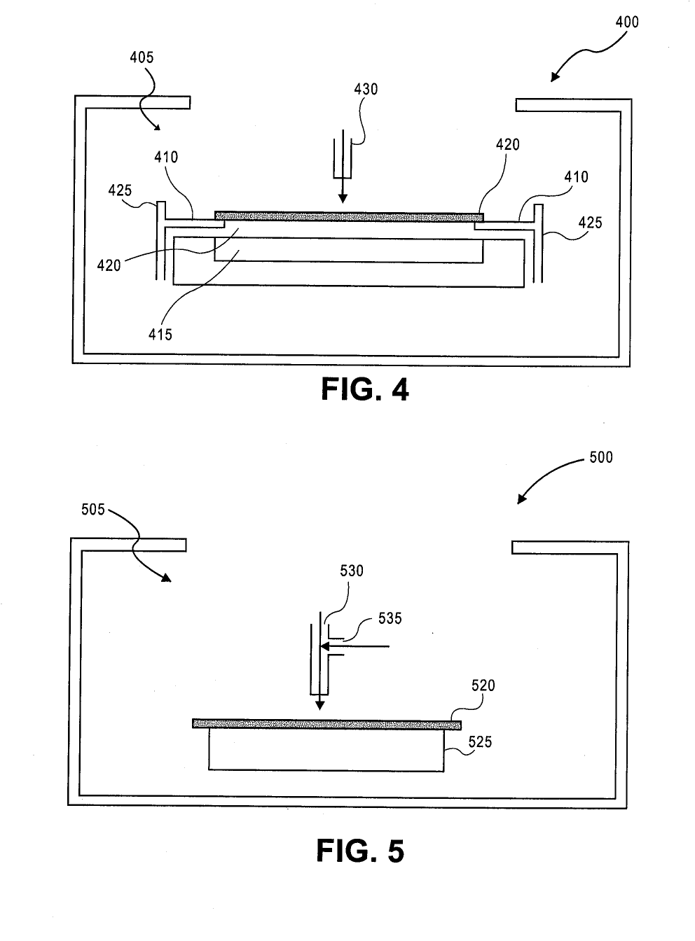

“Jet nozzle cleaning” refers to a cleaning process in which a cleaning fluid is expelled from a nozzle at high velocity with small droplets and directed to a template for cleaning thereof. In some applications, jet nozzle cleaning can be performed in a chamber such as the Tempest, available from Applied Materials, Inc., California, U.S.A (see FIG. 5). To remove any residual adhesive, jet nozzle cleaning can be performed at between about 15 mm to about 70 mm from the surface of mask in combination with a cleaning solution. In some applications, the cleaning solution is an APM or O3/DI solution at a temperature from about 37⁰ C to about 50⁰ C combined with a gas such as nitrogen gas. In some applications, jet nozzle cleaning can be performed on the photomask from between about 2 minutes to about 10 minutes. An advantage of using a physical cleaning method is that harsh chemical agents, such as SPM, do not have to be used. SPMs leave sulfur on the surface of the photomask, thus adversely affecting downstream processing operations in photomask fabrication.

Subsequent to cleaning the photomask, a drying process can be used to dry the photomask. Drying can be performed by spin drying or like processes. In one embodiment of spin drying, the photomask can rotate between about 700 rpm (73.30 rad/s) and about 1000 rpm (104.72 rad/s) for between about 40 seconds and 60 seconds. Subsequent to drying, the photomask can be inspected for the presence of particles. Inspection can be done visually by microscope. If the photomask does not pass inspection, the processes described previously can be repeated. If the photomask passes inspection, the photomask can be repaired and a new pellicle can be attached thereafter. The new pellicle is attached using adhesives such as polybutene resin, polyvinyl acetate resin, acrylic resin, silicon resin, epoxy resin and fluoroplastics.

FIG. 3 illustrates a side view of an apparatus containing a photomask for use in an embodiment of a method for cleaning adhesive from a photomask after removal of a pellicle according to some embodiments the invention. Apparatus 300 can include chamber 305 having an interior volume of a size suitable to contain a photomask or other substrate. FIG. 3 shows photomask 320 positioned on photomask supports 325 within chamber 305. Photomask 320 is placed in chamber 305 following removal of the pellicle frame (not shown) and the pellicle (not shown) from photomask 320. Removal source 330 can be positioned in chamber 305 at a distance from a surface of the photomask having the adhesive, i.e., the surface in which the pellicle frame was previously attached. For example, Removal source 330 can be positioned between about 0.5 mm and about 2.0 mm from the surface of photomask 320. In some embodiments, removal source 330 is an excimer laser. Excimer laser 330 can be programmed at an intensity from about 35 mW/cm² to about 45 mW/cm². In one embodiment, excimer laser 330 is programmed at 40 mW/cm². Removal using the excimer laser can be performed in chamber 305 in an oxygen or air atmosphere at standard pressure (i.e., 760 mmHg). Accordingly, apparatus 300 also includes gas inlet 310 to supply process gas into chamber 305 as well as gas exhaust port 315 to remove process gas. The oxygen or air in introduced into chamber 305 through inlet 310. Used oxygen or air is expelled through exhaust 315. In some embodiments, the oxygen or air is continuously flowing during removal. In some embodiments, the application time to remove the adhesive is from about 8 minutes to about 12 minutes, preferably about 10 minutes.

FIG. 4 illustrates a side view of an apparatus containing a photomask for use in an embodiment of a method for cleaning residual adhesive from a photomask using megasonic cleaning after removal according to some embodiments of the invention. Apparatus 400 can include chamber 405 having an interior volume of a size suitable to contain a photomask or other substrate. FIG. 4 shows photomask 420 positioned on extensions 435 of photomask supports 425 within chamber 405. Megasonic plate 415 generally can be positioned below extensions 435 of photomask supports 425 leaving area 410 between photomask 420 and megasonic plate 415 once photomask 420 has been positioned on photomask supports 425. Area 410 generally holds deionized water. Nozzle 430 can expel a cleaning solution such as APM or O3/DI solution at a temperature between about room temperature, or about 37⁰ C, and about 50⁰ C Megasonic cleaning can be performed at a frequency between about 950 kiloHertz and about 2 megaHertz in combination with a cleaning solution dispensed from nozzle 420. In some applications, the concentration of the cleaning solution is about 1:2:80 for APM and about 30 ppm for O3/DI. In some applications, megasonic cleaning can be performed on photomask 420 from between about 2 minutes to about 10 minutes.

FIG. 5 illustrates a side view of an apparatus containing a photomask for use in an alternative embodiment of a method for cleaning residual adhesive from a photomask using jet nozzle cleaning after removal according to some embodiments of the invention. Apparatus 500 can include at least chamber 505 having an interior volume of a size suitable to contain a photomask or other substrate, support 525 and nozzle 530. For removing residual adhesive, photomask 520 can be positioned on support 525. In some embodiments, jet nozzle cleaning includes the use of at least two fluids. For example, nozzle 530 can simultaneously expel a cleaning solution and an inert gas at photomask 520 to remove residual adhesive therefrom. The inert gas can be fed into the cleaning solution stream at inlet 535, for example. The cleaning solution can be, for example, APM or O3/DI solution at a temperature between about RT, or about 37⁰ C, and about 50⁰ C combined with a gas such as nitrogen gas. In some applications, the concentration of the cleaning solution is about 1:2:80 for APM and about 30 ppm for O3/DI. Jet nozzle cleaning can be performed at a distance from the surface of the mask from between about 15 mm to about 70 mm. In some applications, the jet nozzle stream from nozzle 530 can be specifically directed to the areas on photomask 520 which have residual adhesive, i.e., the periphery of photomask in which the pellicle frame (not shown) was formerly attached. In some applications, jet nozzle cleaning can be performed on photomask 520 from between about 2 minutes to about 10 minutes.

Although discussed with respect to a photomask, embodiments of the invention can be applied to other substrates, such as, but not limited, semiconductor wafers. One of ordinary skill in the art will appreciate that the embodiments of the invention can be performed on a variety of different substrates.

In the foregoing specification, specific embodiments have been described. It will, however, be evident that various modifications and changes can be made thereto without departing from the broader spirit and scope of the appended claims. The specification and drawings are, accordingly, to be regarded in an illustrative rather than a restrictive sense.

What is claimed is:

1. A method comprising:
removing a substance on a photomask from which a pellicle has been removed wherein the removing comprises application of non-chemical energy to the substance; and
subjecting any remaining substance on the photomask to a physical cleaning process.

2. The method of claim 1, wherein the substance is an adhesive.

3. The method of claim 1, wherein the removal is performed by an excimer laser focusing a beam of ultraviolet light at the substance.

4. The method of claim 3, wherein the wavelength of the light is between 165 nanometers and 185 nanometers.

5. The method of claim 3, wherein the intensity of the light is between 38 W/cm² and 42 W/cm².

6. The method of claim 3, wherein the removal is performed at a distance from the photomask between 0.5 millimeters and 2.0 millimeters.

7. The method of claim 3, wherein the removal is performed in a chamber having one of oxygen gas or air.

8. The method of claim 3, wherein the removal is performed for between 8 minutes and 12 minutes.

9. The method of claim 1, wherein the physical cleaning process is one of megasonic cleaning or jet nozzle cleaning.

10. The method of claim 2, wherein the adhesive is selected from the group consisting of polybutene resin, polyvinyl acetate resin, acrylic resin, silicon resin, epoxy resin and fluoroplastics.

11. A method comprising:
removing a pellicle from a photomask;
removing an adhesive remaining on the photomask after pellicle removal wherein the removing comprises application of a non-chemical source to the adhesive; and
cleaning a remaining residue of the adhesive on the photomask using a physical cleaning method.

12. The method of claim 11, further comprising:
after cleaning, drying the photomask;
after drying, inspecting the photomask; and
after inspecting, attaching a second pellicle to the photomask.

13. The method of claim 11, wherein the removal of the adhesive is performed with ultraviolet light from an excimer laser at 172 nanometers.

14. The method of claim 13, wherein the removal of the adhesive is performed at a distance from the photomask between 0.5 millimeters and 2.0 millimeters.

15. The method of claim 13, wherein the removal of the adhesive is performed in a chamber having one of oxygen gas or air.

16. The method of claim 13, wherein the removal of the adhesive is performed for between 8 minutes and 12 minutes.

17. The method of claim 11, wherein the physical cleaning method is one of megasonic cleaning or jet nozzle cleaning.

18. The method of claim 17, wherein the physical cleaning method is megasonic cleaning in a chamber at between 950 kiloHertz and 2 megaHertz.

19. The method of claim 18, wherein a cleaning solution in the chamber is one of an ammonia/hydrogen peroxide mixture or ozone in deionized water at between 37 degrees Celsius and 50 degrees Celsius.

20. The method of claim 19, wherein megasonic cleaning is performed between 2 minutes and 10 minutes.

21. The method of claim 17, wherein the physical cleaning method is jet nozzle cleaning.

22. The method of claim 21, wherein a cleaning solution in the chamber is one of an ammonia/hydrogen peroxide mixture or ozone in deionized water at between 37 degrees Celsius and 50 degrees Celsius.

23. The method of claim 22, wherein jet nozzle cleaning is performed between 2 minutes and 10 minutes.

24. The method of iclaim 11, wherein the adhesive is selected from the group consisting of polybutene resin, polyvinyl acetate resin, acrylic resin, silicon resin, epoxy resin and fluoroplastics.
